(19) United States
(12) Patent Application Publication
(10) Pub. No.: US 2001/0038209 A1
(43) Pub. Date: Nov. 8, 2001

(54) adjustable bolt for a lock

(76) Inventor: Ming-Hsiang Chiu, Chia-I City (TW)

Correspondence Address: Jackson Walker L.L.P., Suite 2100, 112 E. Pecan Street, San Antonio, TX, 78205, US

(21) Appl. No.: 09/804,736

(22) Filed: Mar. 13, 2001

(30) Foreign Application Priority Data
May 6, 2000 (TW) 089209619

(51) Int. Cl. E05C 1/00

(52) U.S. Cl. 292/1.5

(57) ABSTRACT

An adjustable bolt for a lock has a hollow body, a tongue, and two arms. Two retaining plates sandwich the arms therebetween. Each of the retaining plates has a slot defined therethrough. A sleeve pushing the arms extends through the slots of the retaining plates. The slot in one of the retaining plates has two circular portions defined at two ends thereof, and a middle portion between the circular portions, wherein a diameter of the circular portions is larger than a width of the middle portion. A resilient member is provided on a second end of the sleeve to immovably receive the first step in one of the circular portions. Whereby, by releasing the first step from the circular portion, the sleeve is able to be moved along the first slot for changing a distance from the sleeve to the tongue.

### BACKGROUND OF THE INVENTION

1. Field of the Invention

The present invention is related to a lock, and more particularly to an adjustable bolt for the lock.

2. Description of Related Art

For adapted to doors with various distances from keyholes to doorframes, door locks generally have adjustable bolts.

Referring to FIG. 9, a first conventional adjustable bolt has a hollow body (70), a tongue (71), and a pair arms (72) engaged with the tongue (71). The arms (72) each have teeth (721) formed thereon. A first retaining plate (73) and a second retaining plate (74) are respectively provided at a front side and a rear side of the arms (72). A first slot (731) and a second slot (741) are respectively defined through the first retaining plate (73) and the second retaining plate (74). An adjusting plate (75) with a U-shape cross section is sandwiched between the first and second retaining plates (73, 74). A sleeve (76) to align with a keyhole of a door, extends through the first and second slots (731, 741) and is assembled with the adjusting plate (75). The sleeve (76) has wings (761) extending outwards for pushing the teeth (721) to lock or unlock a door. A user can pull the adjusting plate (75) to move the sleeve (76) along the slots (731, 741) to change the distance from the sleeve (76) to the tongue for adapting to various doors, as shown in FIG. 10.

However, because the sleeve (76) is freely provided in the slots (731, 741) after the lock is assembled on a door, when turning it to lock or unlock the door, the sleeve (76) may offset from the keyhole and the wings (761) will be disengaged from the teeth (721). In this case, the door is unable to be opened or closed.

Referring to FIG. 11, a second conventional adjustable bolt also has a hollow body (80), and two retaining plates (81) each with a slot (811). A positioning plate (83) is provided between the retaining plates (81) and a sleeve (82) extends through the slots (811) and the positioning plate (83). The positioning plate (83) has two protrusions (831) formed thereon and abutting a flange (not numbered) of the sleeve (82) to push the sleeve (82) against an inner wall of the retaining plates (81). Furthermore, a resilient member (not shown or numbered) is provided on the sleeve (82) to increase friction between the sleeve (82) and the retaining plates (81). The objective of the conventional adjustable bolt is to prevent the sleeve (82) from moving by the friction. However, the friction is not enough to completely prevent the sleeve (82) from moving.

Referring to FIG. 12, a third conventional adjustable bolt also has two retaining plates (90) each with a slot (91). In one of the retaining plates (90), two circular portions (92) are respectively defined at two ends of the slot (91), and two stops (93) are respectively formed at upper and lower edges of the slot (91). A positioning plate (94) with two protrusions (941) is provided on a first end of a sleeve (95), and a resilient member (96) is provided on a second end of the sleeve (95) and abuts an inner wall around the circular portion (92). By the protrusions (941), the resilient member (92) and the stops (93), the sleeve (95) is positioned in the circular portion (92). In adjustment of the bolt, the sleeve (95) is forced to move along the slot (91) under a large external force. Thus, if there is a large force in locking or unlocking the door, the sleeve (95) also will have unwanted movement.

Therefore, the invention provides an improved adjustable bolt to mitigate and/or obviate the aforementioned problems.

### SUMMARY OF THE INVENTION

The main objective of the invention is to provide an adjustable bolt which can be securely positioned to prevent a sleeve from unwanted movement during locking or unlocking of a door.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of an adjustable bolt for a lock in accordance with the invention;

FIG. 2 is a front view of the adjustable bolt in FIG. 1;

FIG. 3 is a top view of the adjustable bolt in FIG. 1;

FIG. 4 is a top view showing the bolt in FIG. 1 being adjusted;

FIG. 5 is a top view showing the bolt in FIG. 1 having been adjusted;

FIG. 6 is a front view of FIG. 5;

FIG. 7 is an exploded perspective view of a second embodiment in accordance with the invention;

FIG. 8 is an exploded perspective view of a third embodiment in accordance with the invention;

FIG. 9 is a top view of a first conventional bolt for a lock;

FIG. 10 is a top view showing the bolt in FIG. 9 being adjusted;

FIG. 11 is an exploded perspective view of a second conventional bolt for a lock; and

FIG. 12 is an exploded perspective view of a third conventional bolt for a lock.

### DETAILED DESCRIPTION OF THE PREFERRED EMBODIMENT

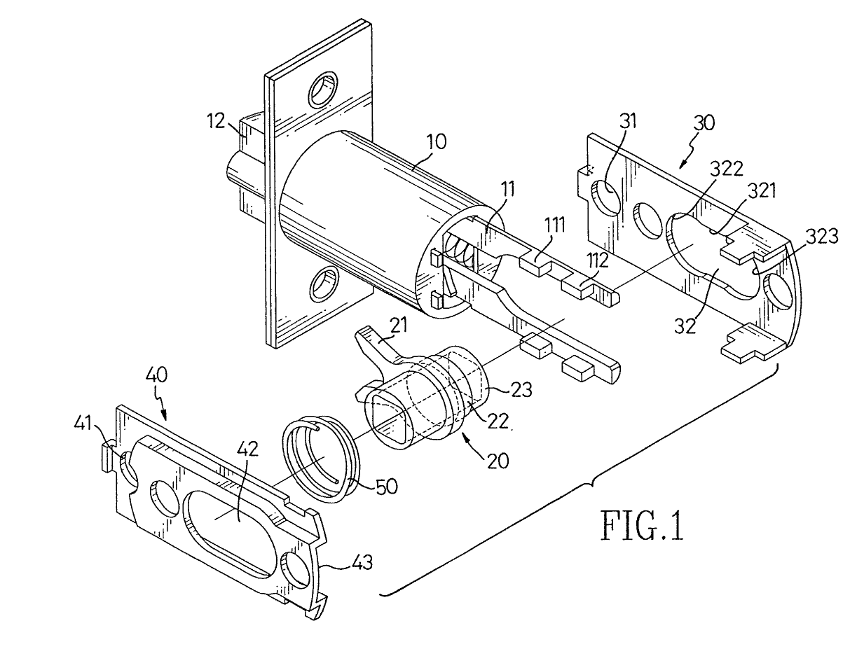

Referring to FIG. 1, according to the present invention, an adjustable bolt for a lock comprises a hollow body (10), a tongue (12) movably extending out of a first end of the hollow body (10), and two arms (11) movably extending out of a second end of the hollow body (10) and engaged with the tongue (12) inside the body (10). The arms (11) are disposed one above the other and have a common vertical plane, and are symmetrical to each other when viewed from the side. Each of the arms (11) has a first tooth (111) and a second tooth (112) formed thereon. A sleeve (20) is provided between the arms (11) and has wings (21) radially extending outwards. When the sleeve (20) is turned, the wings (21) push the teeth (111, 112) respectively to move the arms (11) and to retract the tongue (12) for unlocking a door.

The arms (11) are sandwiched between a first retaining plate (30) and a second retaining plate (40). The first retaining plate (30) has a plurality of first holes (31) and a first slot (32) defined therein, and the second retaining plate (40) has a plurality of second holes (41) and a second slot (42) to align with the respective first holes (31) and the first slot (32). The first slot (32) has a first circular portion (322) and a second circular portion (323) defined at two ends thereof and a middle portion (321) formed between the circular portions (322, 323), wherein the middle portion (321) is narrower than the circular portions (322, 323), ie, the width of the middle portion (321) is less than the diameter of the circular portions (322, 323). A channel (43) is longitudinally defined in an inner surface of the second retaining plate (40).

The sleeve (20) aligned with a keyhole (not shown or numbered), extends through the first retaining plate (30) and the second retaining plate (40), and has a first step (22) and a second step (23) formed at a first end thereof extending through the first slot (32). A diameter of the first step (22) is larger than that of the second step (23) and larger than the width of the middle portion (321) of the first slot (32), but smaller than the diameter of the circular portions (322, 323) of the first slot (32). The diameter of the second step (23) is smaller than the width of the middle portion (321).

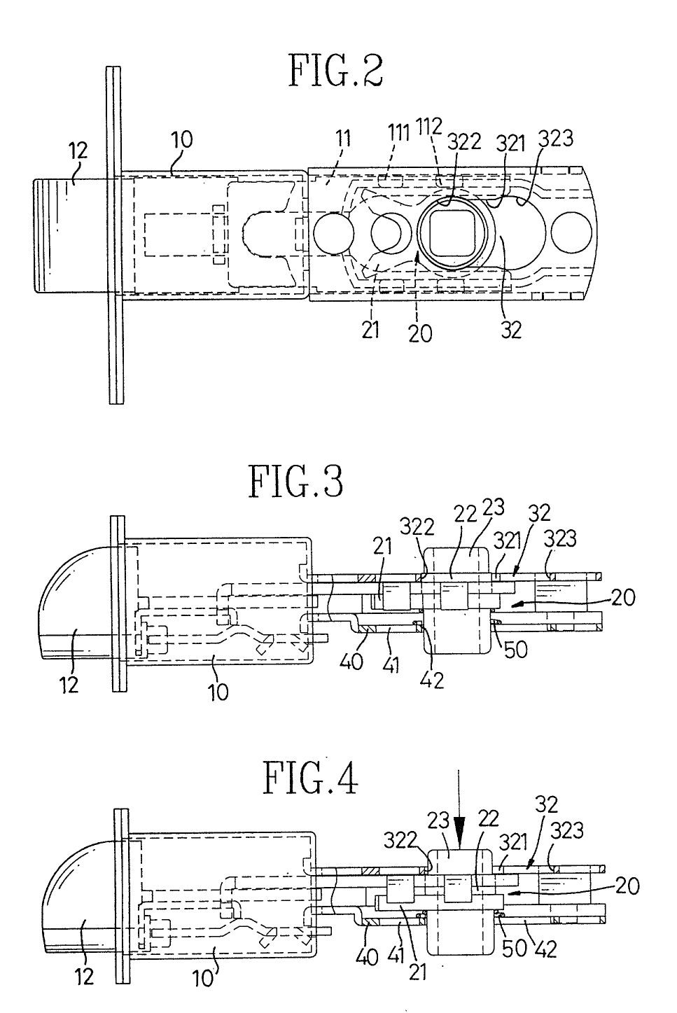

Referring to FIG. 3, a resilient member (50) is provided on a second end of the sleeve (20) and received in the channel (43). Thus, under the force of the resilient member (50), the first step (22) is securely received in the first circular portion (322) of the first slot (32), as shown in FIGS. 2 and 3. Because the first step (22) is blocked by the middle portion (321), the sleeve (20) is unable to be moved along the first slot (32) when the sleeve (20) is turned.

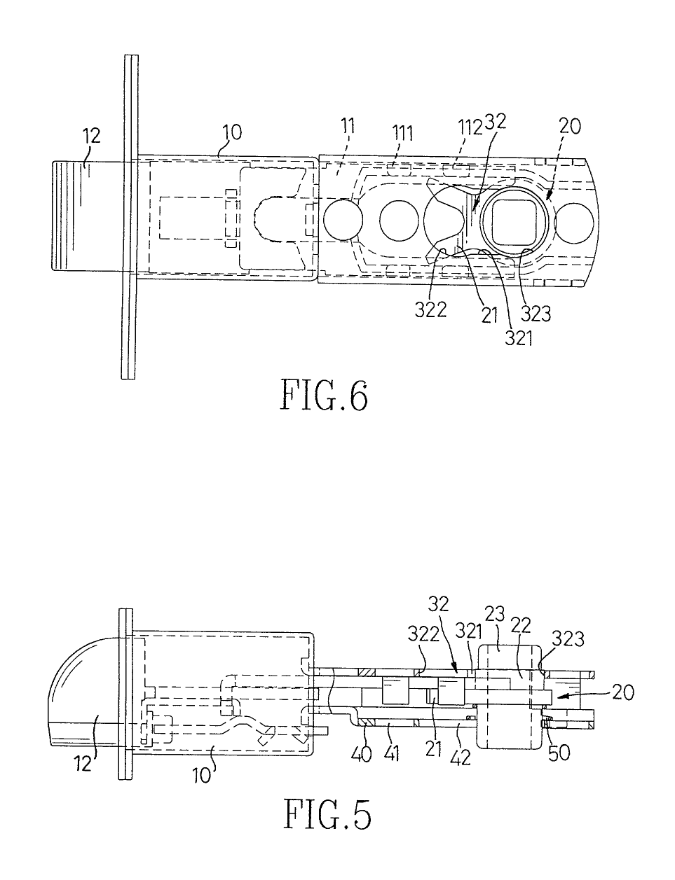

Referring to FIG. 4, in adjustment of the bolt, the sleeve (20) is pressed towards the second retaining plate (40), as indicated by the arrow, to release the first step (22) from the first circular portion (322). While the second step (23) is received in the first circular portion (322), the sleeve (20) is able to be moved along the first slot (32) to arrive at the second circular portion (323), as shown in FIGS. 5 and 6. Afterwards, the resilient member (50) is released, and the first step (22) is securely received in the second circular portion (323).

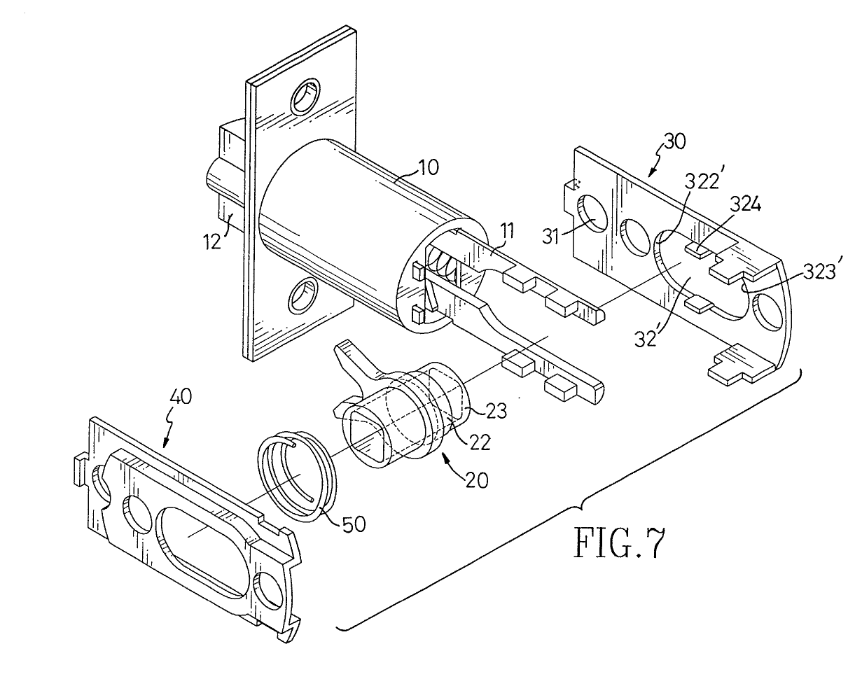

Referring to FIG. 7, in a second embodiment of the invention, the diameter of each of the circular portions (322′, 323′) of the first slot (32″) is equal to the width of the middle portion. The first retaining plate (30) has two stops (324) respectively formed at upper and lower edges of the middle portion. A distance between the stops (324) is smaller than the diameter of the circular portions (322, 323) and smaller than the diameter of the first step (22) but larger than the diameter of the second step (23). Thus, the first step (22) is blocked by the stops (324) and unable to be moved along the slot (32′) under the force of the resilient member (50).

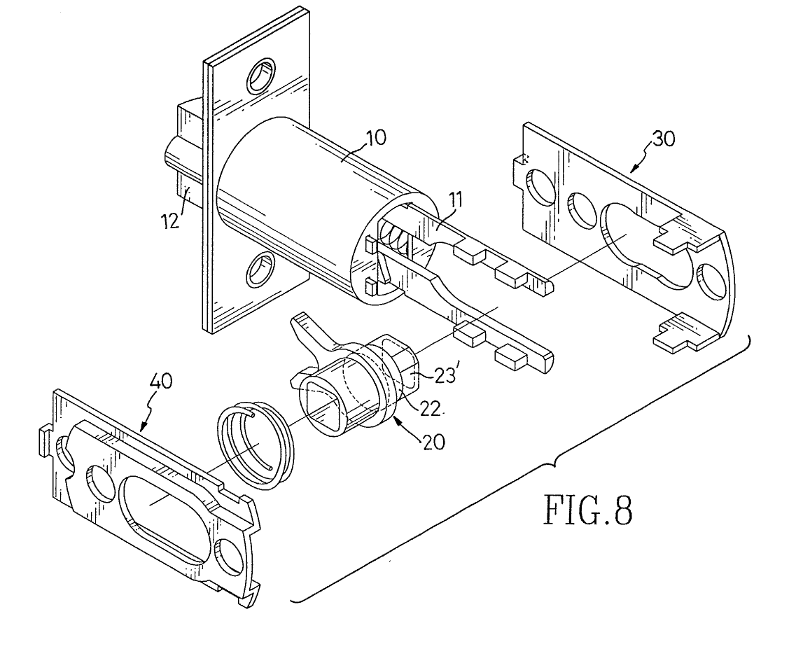

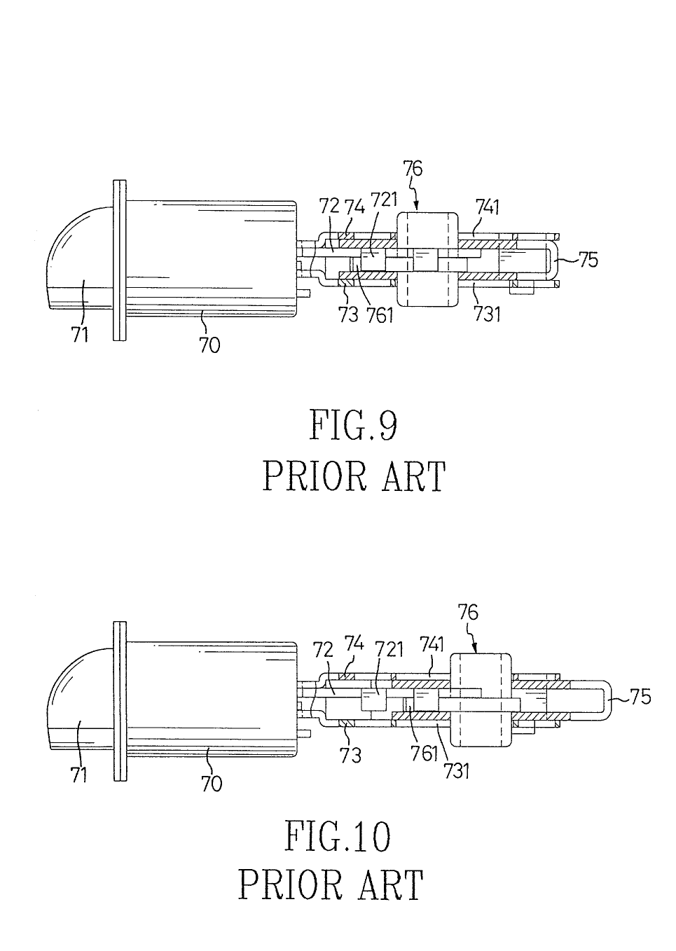

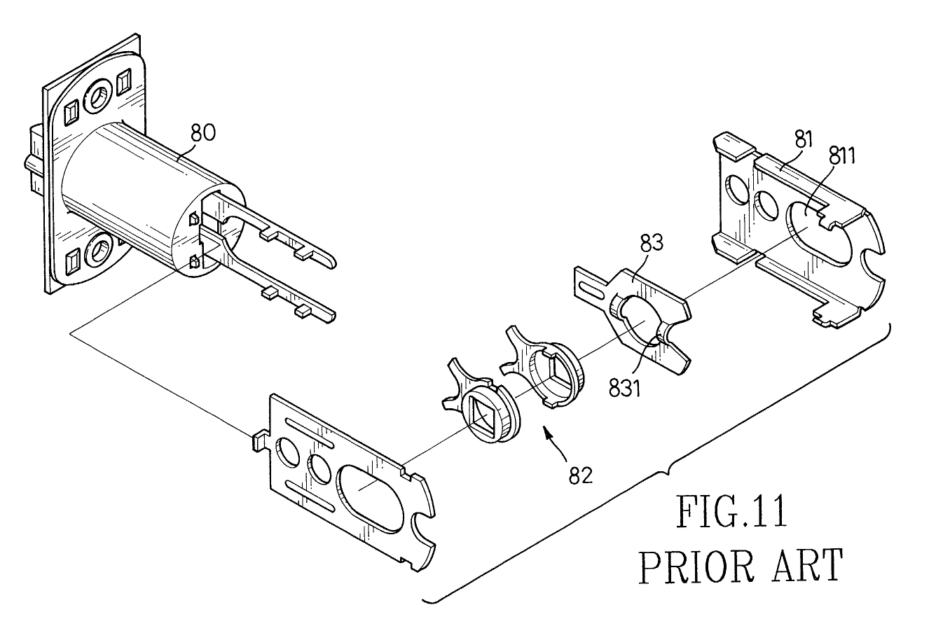

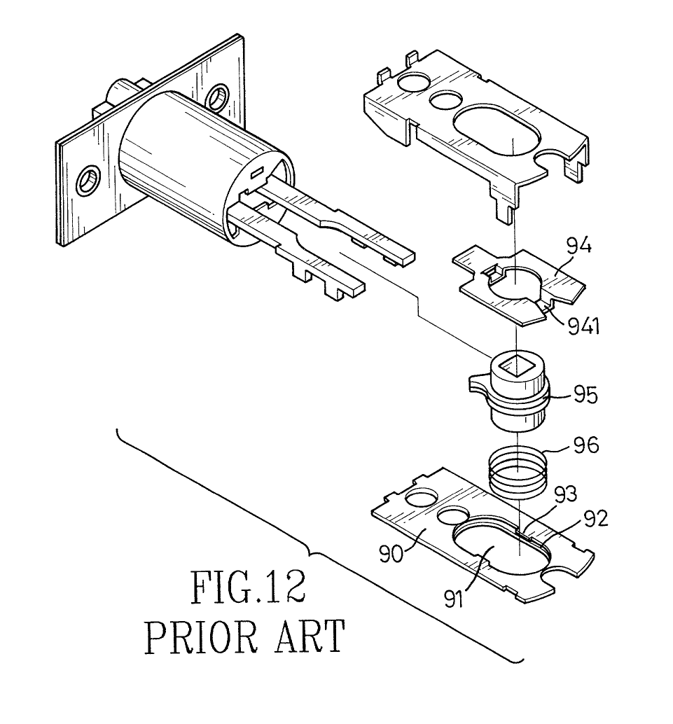

In a third embodiment as shown in FIG. 8, the second step (23′) of the sleeve (20) has an outer periphery square in cross-section.

From the above description, it is noted that the invention has the following advantages:

1. The sleeve is securely positioned in the slots and will not have unwanted movement during locking or unlocking the door.

2. The structure of the invention is simple and the manufacturing cost is low.

3. It is very convenient for a user to adjust the bolt by using only one hand.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjustable bolt for a lock, comprising:
a hollow body (10);
a tongue (12) movably extending out of a first end of the hollow body (10);
two arms (11) movably extending out of a second end of the hollow body (10) and engaged with the tongue (12) inside the body (10), wherein the arms (11) are arranged one above the other and are symmetrical with each other, and each have a first tooth (111) and a second tooth (112) formed thereon;
a first retaining plate (30) and a second retaining plate (40) to sandwich the arms (11) therebetween, the first retaining plate (30) having a plurality of first holes (31) and a first slot (32), and the second retaining plate (40) having a plurality of second holes (41) and a second slot (42) to align with the respective first holes (31) and the first slot (32), wherein the first slot (32) has a first circular portion (322) and a second circular portion (323) respectively formed at two ends thereof, and a middle portion (321) formed between the circular portions (322, 323), wherein a diameter of the circular portions (322, 323) is larger than a width of the middle portion (321);
a sleeve (20) provided between the arms (11) and extending through the first slot (32) and the second slot (42), the sleeve (20) having two wings (21) extending outwards for pushing the teeth (111, 112) to retract the tongue (12), and having a first step (22) and a second step (23) formed at a first end which extends through the first slot (32), wherein a diameter of the first step (22) is larger than the width of the middle portion (321), and the second step (23) is adapted to be movable in the first slot (32); and
a resilient member (50) provided on a second end of the sleeve (20) to immovably receive the first step (22) in the first circular portion (322);
whereby, by being pressed towards the second retaining plate (40) to release the first step (22) from the first circular portion (322), the sleeve (20) is able to be moved along the first slot (32) to arrive at the second circular portion (323).

2. The adjustable bolt as claimed in claim 1, wherein the second step (23) has a circular cross-section.

3. The adjustable bolt as claimed in claim 1, wherein the second step (23) has a square cross-section.

4. The adjustable bolt as claimed in claim 1, wherein the second retaining plate (40) has a channel (43) longitudinally defined at an inner surface thereof, and the resilient member (50) is received in the channel (43).

5. An adjustable bolt for a lock, comprising:
a hollow body (10);
a tongue (12) movably extending out of a first end of the hollow body (10);
two arms (11) movably extending out of a second end of the hollow body (10) and engaged with the tongue (12) inside the body (10), wherein the arms (11) are arranged one above the other and are symmetrical with each other, and each have a first tooth (111) and a second tooth (112) formed thereon;
a first retaining plate (30) and a second retaining plate (40) to sandwich the arms (11) therebetween, the first retaining plate (30) having a plurality of first holes (31) and a first slot (32), and the second retaining plate (40) having a plurality of second holes (41) and a second slot (42) to align with the respective first holes (31) and the first slot (32), wherein the first slot (32) has a first circular portion (322) and a second circular portion (323) formed at two ends thereof, and two stops (324) respectively formed at upper and lower edges between the circular portions (322, 323), wherein a diameter of the circular portions (322, 323) is larger than a distance between the stops (324);
a sleeve (20) provided between the arms (11) and extending through the first slot (32) and the second slot (42), the sleeve (20) having two wings (21) extending outwards for pushing the teeth (111, 112) to retract the tongue (12), and having a first step (22) and a second step (23) formed at a first end which extends through the first slot (32), wherein a diameter of the first step (22) is larger than the distance between the stops (324), and the second step (23) is adapted to be movable in the first slot (32); and
a resilient member (50) provided on a second end of the sleeve (20) to immovably receive the first step (22) in the first circular portion (322);
whereby, by being pressed towards the second retaining plate (40) to release the first step (22) from the first circular portion (322), the sleeve (20) is able to be moved along the first slot (32) to arrive at the second circular portion (323).

6. The adjustable bolt as claimed in claim 1, wherein the second step (23) has a circular cross-section.

7. The adjustable bolt as claimed in claim 1, wherein the second step (23) has a square cross-section.

8. The adjustable bolt as claimed in claim 1, wherein the second retaining plate (40) has a channel (43) longitudinally defined at an inner surface thereof, and the resilient member (50) is received in the channel (43).
